(19) United States
(12) Patent Application Publication
(10) Pub. No.: US 2016/0333532 A1
(43) Pub. Date: Nov. 17, 2016

(54) Apparatus and Method for Installing Utility Service Lines in Road Pavements

(71) Applicant: Shahriar Eftekharzadeh, Torrance, CA (US)

(72) Inventor: Shahriar Eftekharzadeh, Torrance, CA (US)

(21) Appl. No.: 15/220,246

(22) Filed: Jul. 26, 2016

(51) Int. Cl. E01C 9/00; E01C 1/00; F16L 1/06; F16L 3/14; E01F 5/00; F16L 1/032

(52) U.S. Cl. CPC E01C 9/002; E01F 5/005; F16L 1/032; F16L 1/06; F16L 3/14; E01C 1/00; E01C 9/001; E01C 2201/00

(57) ABSTRACT

An apparatus and a method for installing pipes and conduits in road pavements with minimum cover.

### FIELD OF THE INVENTION

The present invention pertains to utility service lines within the right-of-way of public roads and streets. More specifically, the present invention provides an apparatus and a method for installing pipes and conduits in road pavements with minimum cover.

### BACKGROUND OF THE INVENTION

Transportation, communications, and utility networks are essential components of modern life. A major part of such networks are pipelines and cables that run below the surface mostly in the right-of-way of public roads and streets. Increasingly, the possibility of two or more utility lines conflicting or intersecting is a problem as the need for services grow and the space underneath roads becomes congested, making the availability of new alignments and construction of new utility service lines difficult in urban areas. Utility service lines take the form of a conduit or pipeline, which are herein used interchangeably with utility service lines to mean the same.

Current standards and guidelines require a minimum cover depth below the road pavement for buried pipelines and conduits to protect the pipe against surface loads, exposure, and temperature, and to maintain the integrity and safety of the road. There are currently no utility lines permitted within the road pavement for concern of adverse impact on the safety, integrity, construction, operation, and maintenance of public roads by transportation authorities.

The vertical space beneath the road surface that is the pavement is currently only utilized for bearing and transfer of the traffic load above to the natural ground formation below and as such is a grossly underutilized resource. Structurally, this space could accommodate one or more conduits without compromising its load bearing and load transfer properties while maintaining its safety and integrity, and thus be used to route utility service lines without any adverse impacts. The road pavement is currently only used to accommodate utility service line in special circumstances such as road crossings by means of encasement of commercial pipe in reinforced concrete, a method not suitable for long pipelines because of several limitations including small pipe size, extensive volume of steel and concrete, long schedule, and cost. Currently, there are no feasible techniques for constructing pipelines within the road pavement with minimal or no cover depth. Such a technique would enable the utilization of the road pavement to accommodate utility service lines, greatly increase the availability of new pipeline alignments, and constitute a major advancement towards satisfying the utility service needs of modern life.

Therefore, there is a need for a means of increasing the utility of existing road pavements to accommodate utility service lines without adversely affecting the safety, integrity, construction, operation, and maintenance of public roads.

### SUMMARY OF THE INVENTION

The present invention provides a solution for the above stated need with an apparatus and method for both supporting a pipe within its trench and shielding it from direct loads from the roadway above. The invention consists of the required service pipe strapped to the underside of a conventional steel plate of specific dimensions and structural properties plus as shallow “T” section trench excavated within the road pavement to accommodate the steel plate and its strapped pipe. Steel plates are currently used in roads to temporarily cover over utility trenches during construction. The present invention uses them to permanently cover over a trench and divert the forces around while maintaining the strapped pipe suspended in the trench without any contact with the trench perimeter. With this arrangement, the steel plate bears the entire dead and live loads of the roadway above plus the weight of the pipeline below, and the pipeline is not subjected to any external loads other than the straps that keep it suspended inside the trench.

One key advantage of the present invention is that it does not need a minimum cover depth to withstand direct traffic loads and thus allows the pipeline to be placed within the pavement with only the surface course as the cover. Another key advantage of the preset invention is that the pipeline is suspended in the trench and not directly supported by the ground meaning that there are no external forces on the pipeline that could threaten its integrity and safety.

Installation of the present invention is relatively simple and straightforward, particularly compared with existing pipes that require bed preparation, compaction, and backfill soil cover. The apparatus of the present invention is assembled by strapping bell-end pipe segments to corresponding steel plates that are shorter by the length of the spigot. In existing roads, a “T” section trench is excavated in the pavement to accommodate the plurality of steel plates and corresponding strapped pipes. The plates are then sequentially placed in the trench with the bell end facing the spigot. In plastic pipes, jointing compound is applied and the plates are sequentially pulled in to close the gap between consecutive plates and thereby fully insert the spigot into the bell until the plate ends are touching. In steel pipes that require the clamping of the bell and spigot joint, a certain length of the steel plate directly above the joint on either the bell end, the spigot end, or both may be made removable to permit the clamping operation. The installation does not require any bed preparation, backfilling, compaction, etc. of the trench as the pipe is suspended. The void space in the trench may be injected with grout through holes in the plate segments to insure the stability and longevity of the trench and not for load transfer or bearing purposes. In new road construction, the “T” section trench may be molded in the road pavement using formwork.

The present invention can be utilized in a number of embodiments that vary the number, material, and duty of the pipelines placed in the trench. The present invention allows more than one pipeline suspended from the steel plate and a combination of utility service pipes, from pressurized conveyance to cables in conduits. The present invention can be utilized as a single-line pressure pipe of certain diameter conveying a certain pressurized fluid, a multi-line pressure pipe that conveys one or a plurality of different-type fluids, a single or multi-line conduit for various-type cables, or a multi-conduit utility trench for various service lines

It is an object of the present invention to provides a technique for installing pipelines and conduits within road pavements to provide for increased utilization of the road to accommodate utility service lines.

It is an object of this invention to provide improved elements and arrangements by apparatus for the purposes described thereof, which is comparable in cost with existing systems, dependable, and fully effective in accomplishing its intended purposes.

These and other objects of the present invention will become readily apparent upon further review of the following specification and drawings.

### BRIEF DESCRIPTION OF THE DRAWINGS

FIG. 1 is an underside view of a single unit of the present invention showing one pipe segment strapped to the underside of a steel plate that is suitable for covering over a utility trench in roadways.

FIG. 2 is an exploded drawing of a single unit the present invention showing how the pipe segment may be strapped to the steel plate.

FIG. 3 is a top view of a single unit of the present invention showing the assembly the relative lengths of the pipe segment strapped to the underside of a steel plate to expose a spigot.

FIG. 4 is a top view of two units of the present invention fitted together with spigot of one unit inserted inside the bell end of the other.

FIG. 5 shows the shallow “T” section trench excavated in the road pavement to house the present invention.

FIG. 6 shows several units of the present invention installed in the shallow “T” section trench excavated in the road pavement.

FIG. 7 show the present invention once fully installed in the road pavement with the surface course restored.

FIG. 8 is a cut section through the road pavement showing the strapped pipeline suspended in the trench.

FIG. 9 is a cut section through the road pavement showing the suspended pipeline grouted in the trench.

FIG. 10 is an underside view of another embodiment of the present invention having two utility service lines.

FIG. 11 is top view of the same embodiment of the present invention as in FIG. 10 showing the exposed spigot of the two utility service lines.

### DETAILED DESCRIPTION

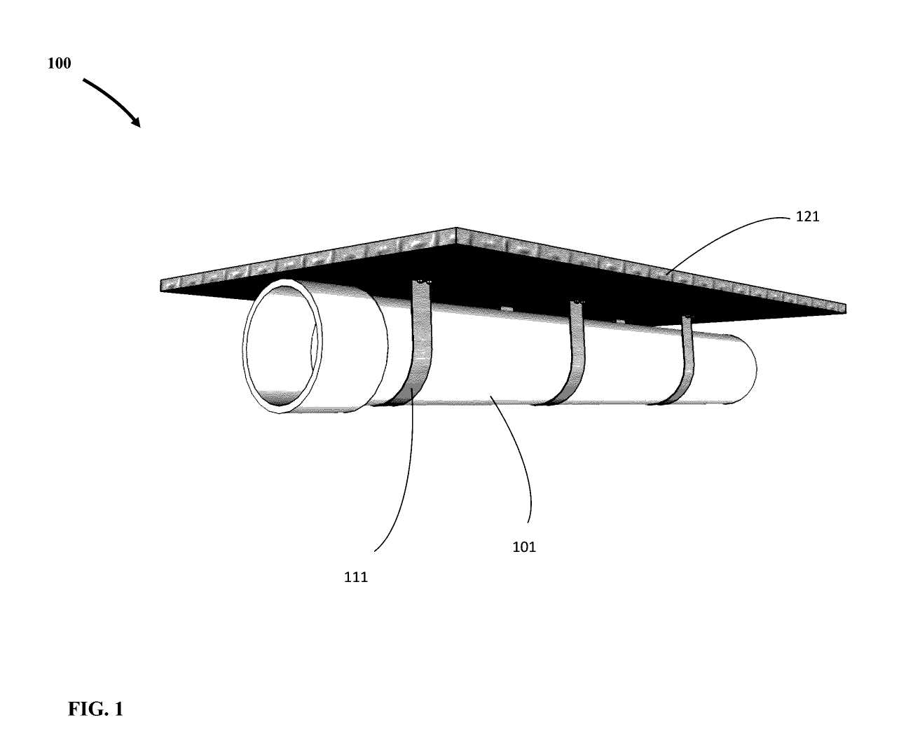

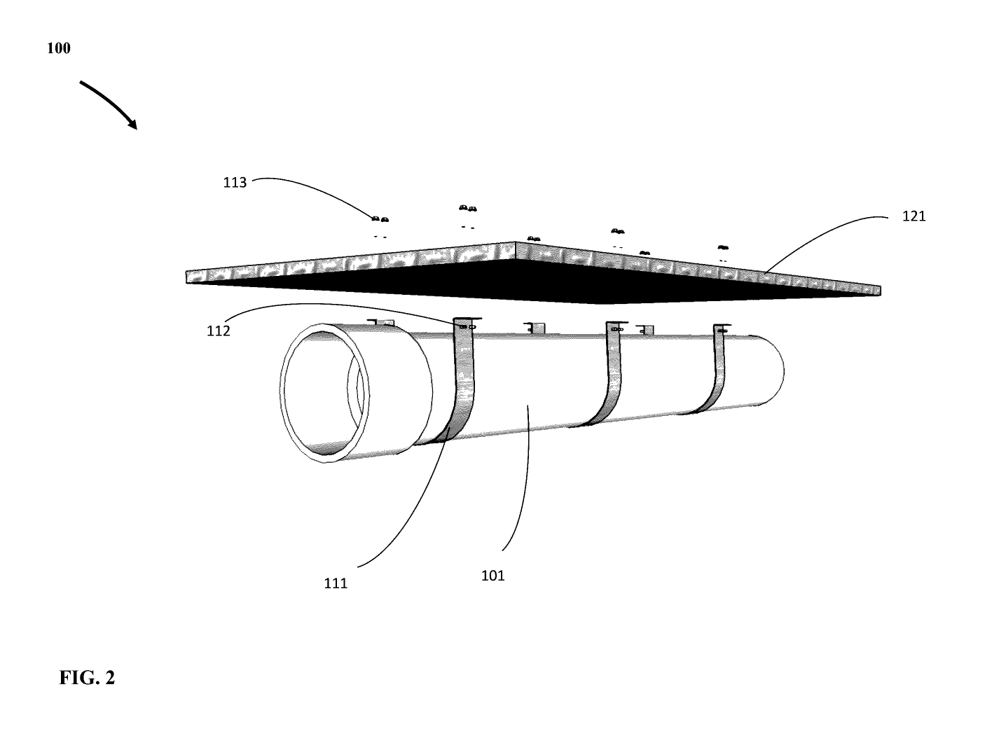

Referring to FIG. 1 there is shown an underside view of a single unit of the present invention 100 showing pipe segment 101 attached to the underside of steel plate 121 by means of straps 111 of required width, strength, and durability. Steel plate 121 is of the type suitable for covering over utility trenches in road ways and is specified and dimensioned accordingly. Pipe 101 may be made of plastic, steel, or other materials and may be purposed for conveyance of pressurized fluids and gasses, or for use as conduit for tubes and cables. Straps 111 function to support the weight of pipe 101 and transfer it to the steel plate 121, and may take different shapes and forms, made from metal in the form of a “U” clamp as shown in FIG. 2, in which case they may be fastened to the steel plate 121 with bolts 113 and nuts 112 or flexible high tensile strength plastic straps used in the art to secure loads on transportation trucks.

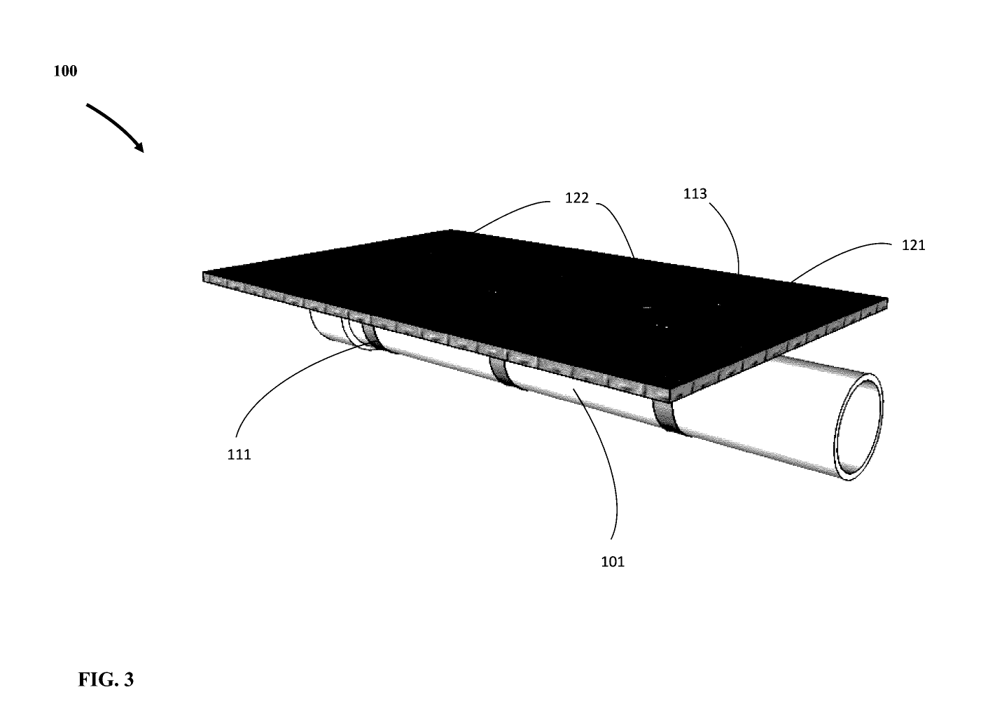

FIG. 3 is a top view of a single unit of the present invention 100 showing that steel plate 121 is shorter than pipe segment 101 to expose a spigot that inserts in the bell end of the next unit. Strap 111 fastens pipe segment 101 to steel plate 121 using bolts 133. Holes 122 in steel plate 121 facilitate lifting and provide access into the voids beneath for grouting.

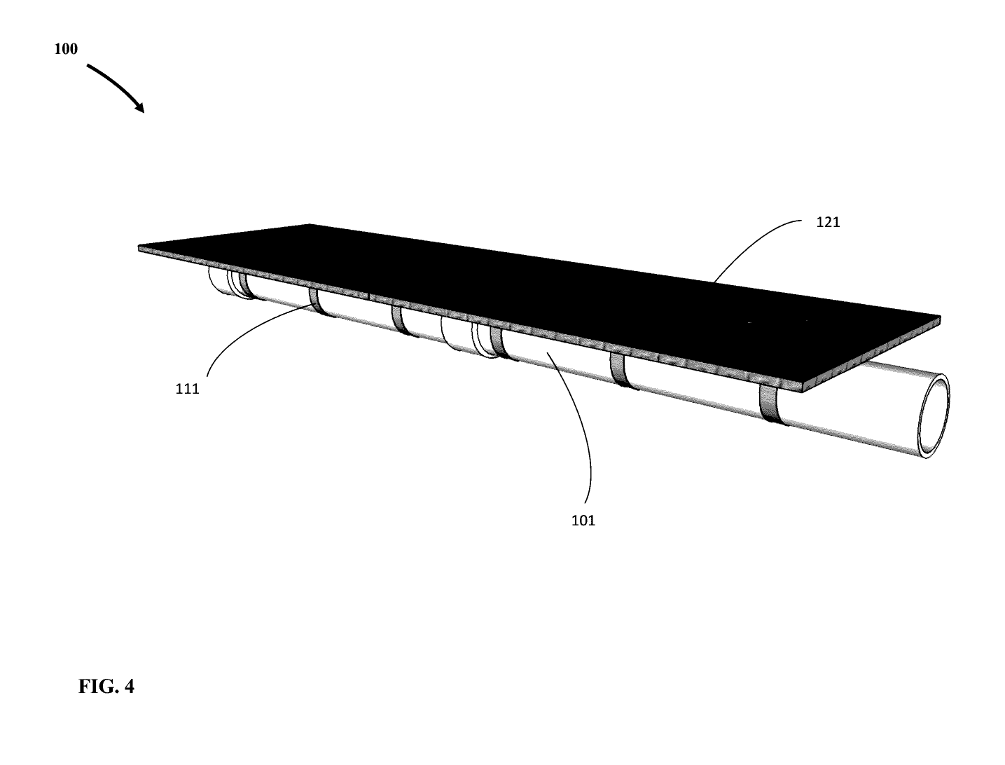

FIG. 4 is a top view of two units of the present invention 100 showing how individual unit fit together. The gap between consecutive plates 121 is fully closed once the spigot and bell ends of consecutive pipes 101 are joined.

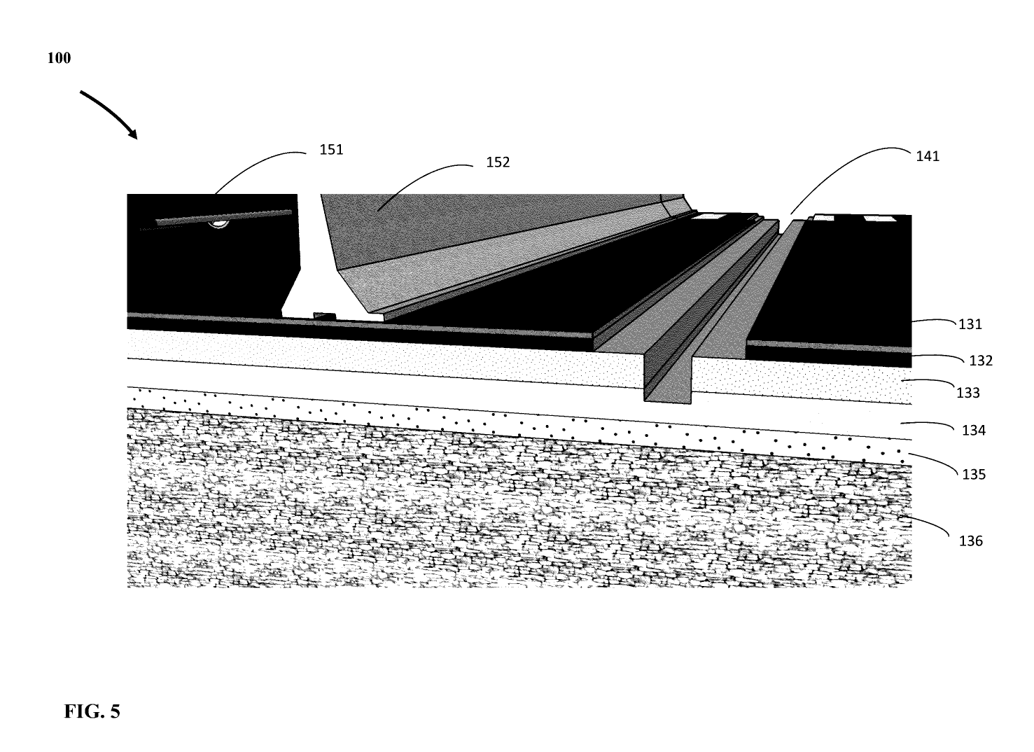

FIG. 5 shows the shallow “T” section trench 141 excavated in a flexible pavement, which typically consist of the road surface 131, surface binder course 132, base course 133, subbase course 134, and compacted ground 135 over natural ground 136. The same “T” section trench 141 could be excavated in a rigid pavement, which would have a concrete slab (not shown) in lieu of the surface course 131 and binder course 132, while the base course 133 and subbase course 134 would have different thicknesses and properties. The upper wide part of trench 141 may only extend a few inches below the surface course 131 to accommodate the steel plate 121 in FIG. 4 while leaving adequate thickness above to restore the surface course 131. The dimension of the lower narrow part of trench 141 is determined by the size of service pipe 101 in FIG. 4 and is sized to leave some clearance between pipe 101 and trench 141 perimeter. The work area is isolates from traffic 151 by barricade 152.

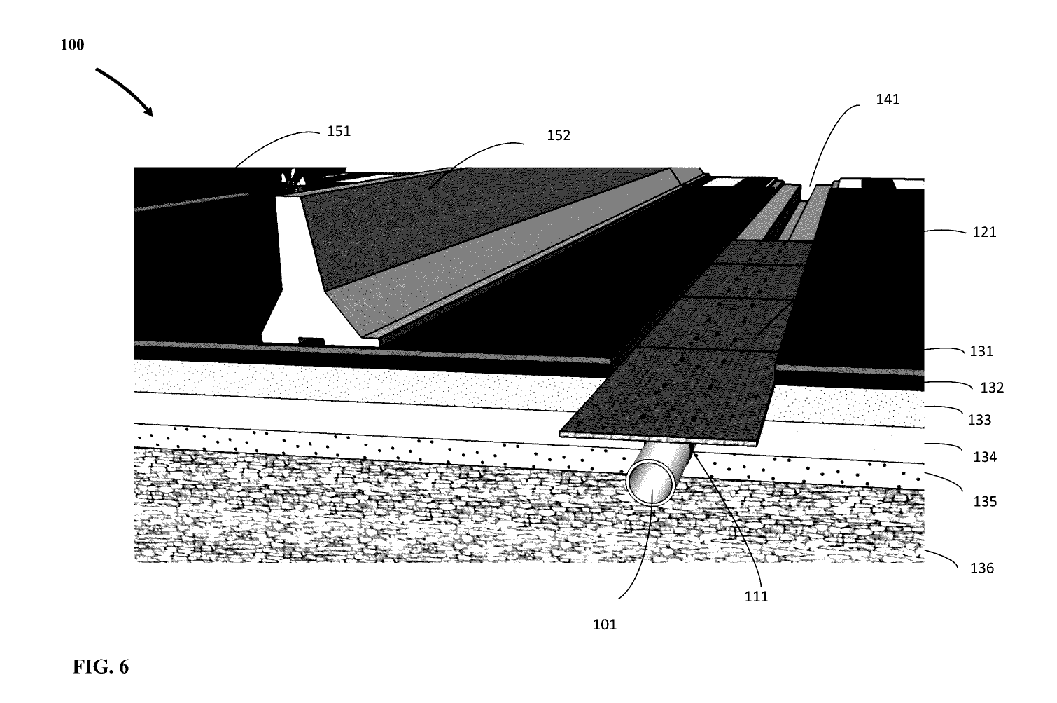

FIG. 6 shows several units of the present invention 100 installed in shallow “T” section trench 141 excavated within the road pavement. Steel plates 121 are placed in trench 141 and supported by the upper section of trench 141 while pipe 101 is suspended inside the lower section of trench 141 by means of straps 111. Steel plates 121 may be secured to surfaces of trench 141 supporting steel plate 121 using a binder coat (not shown) and or railroad nails (not shown).

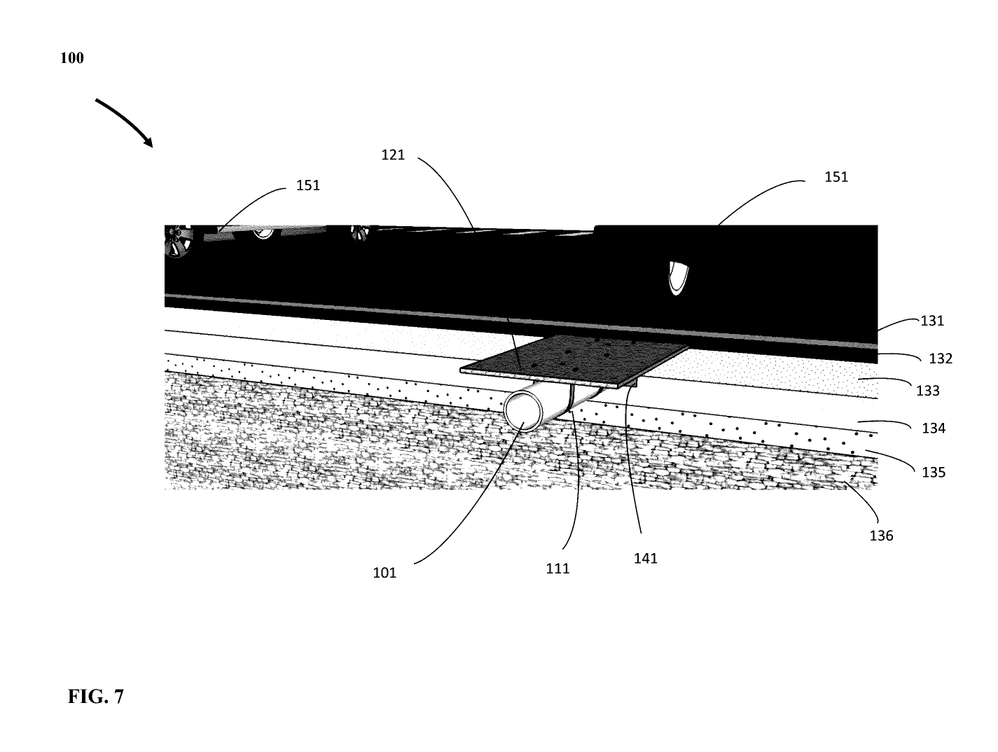

FIG. 7 show the present invention 100 fully installed within the road pavement with surface course 131 restored. Steel plates 121 transfer the load from traffic 151 to base course 133 while shielding pipe 101 from all external loads.

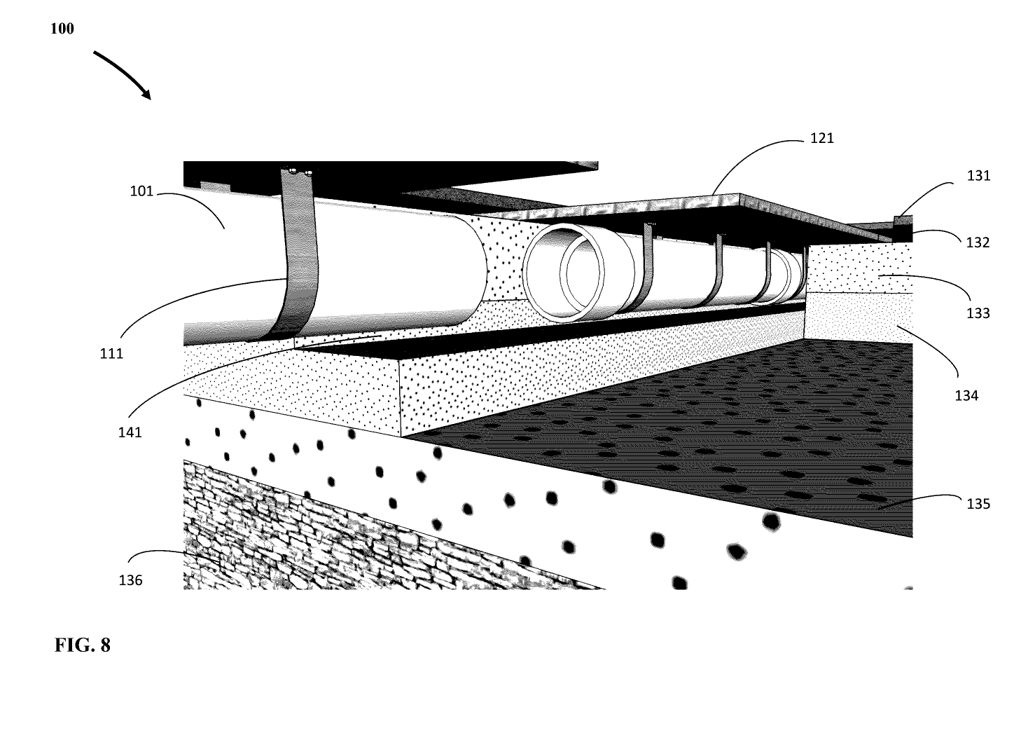

FIG. 8 is a cut section through the road pavement showing the suspended pipeline 101 within trench 141. Steel plates 121 are supported by the upper section of trench 141 and pipe 101 is suspended inside the lower section of trench 141 by means of straps 111. There is no contact between pipe 101 and trench 141.

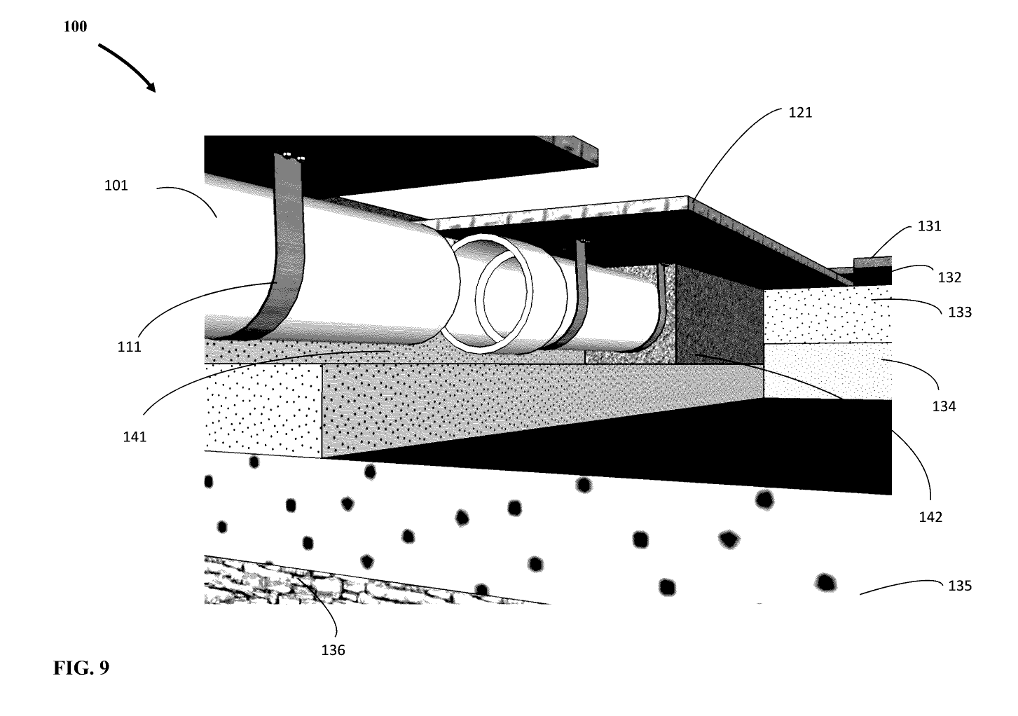

FIG. 9 is a cut section through the road pavement showing the suspended pipeline 101 encased in grout 142 within trench 141. The purpose of grout 142 is to fill the voids in trench 141 and protect from long term impact of the elements while providing lateral support for the vertical walls. Grout 142 is not intended to provide reaction force in vertical plane to support traffic loads.

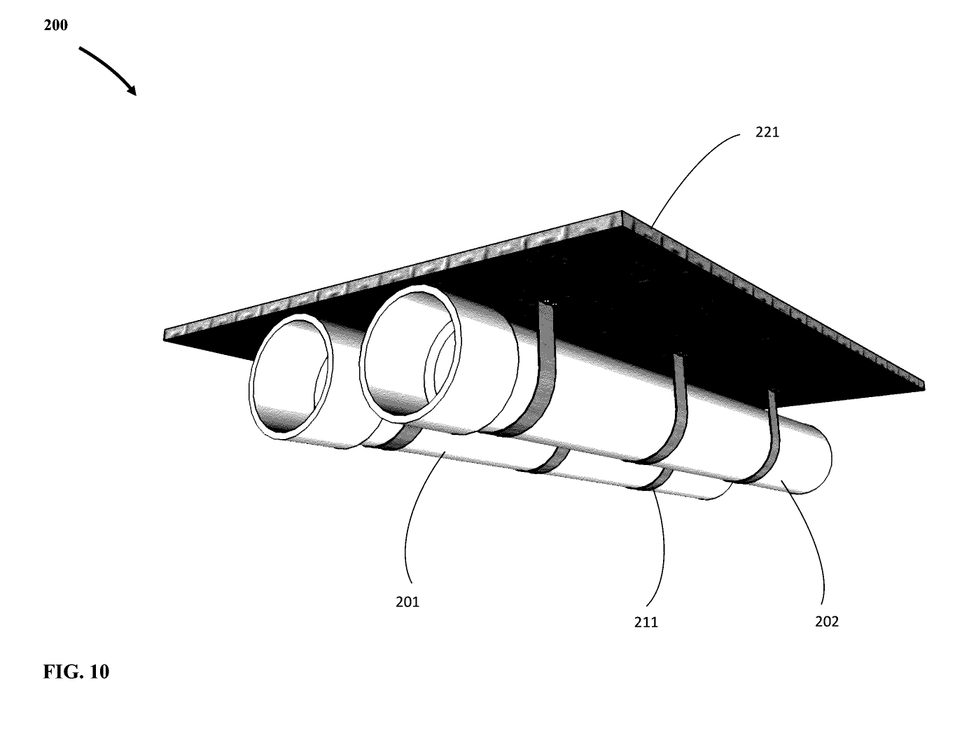

FIG. 10 is an underside view of another embodiment of the present invention 200 having two utility service lines. Steel plate 221 is wide enough to accommodate two utility lines 201 and 202, which are fastened to steel plate 221 by straps 211. Except for a wider trench to accommodate the wider steel plate 221 and utility lines 201 and 202, the other aspects of the embodiment of the present invention 200 shown in FIG. 10 are the same as the single-line embodiment of the present invention 100 shown in FIGS. 1 through 9.

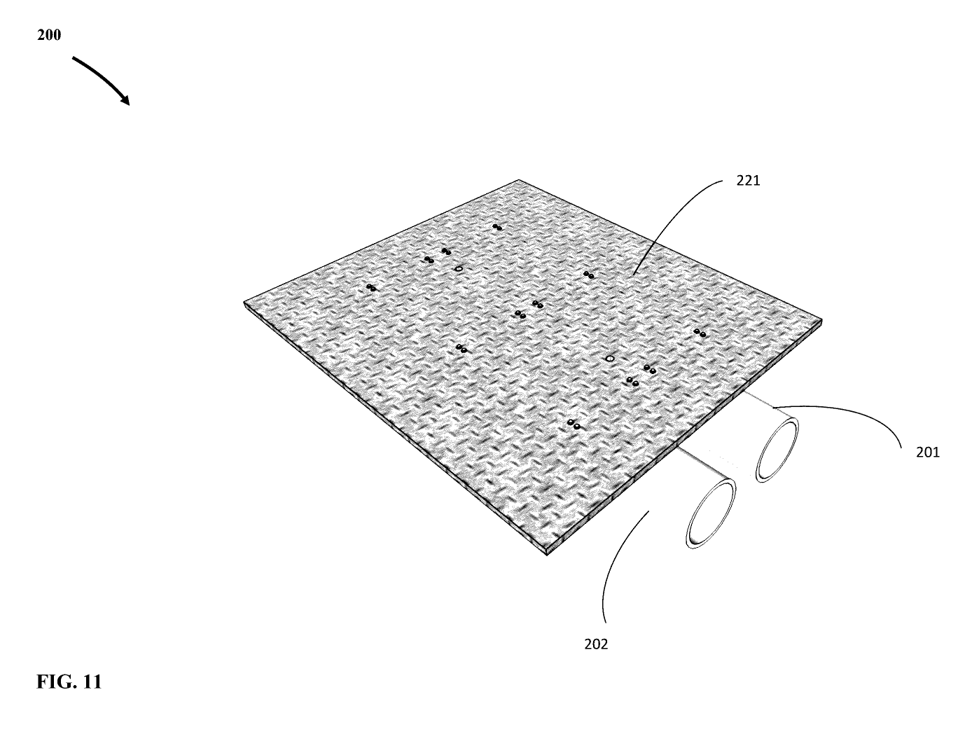

FIG. 11 is the top view of the same embodiment of the present invention 200 as in FIG. 10 showing the exposed spigots of the two utility service lines that fit into corresponding bell end of the adjacent unit.

The present invention is susceptible to modifications and variations which may be introduced thereto without departing from the inventive concepts and the object of the invention. Materials other than steel, such as other metals, composites, plastics, carbon fiber, etc. may be used for bearing and transferring the traffic loads while shielding the service pipe from the traffic loads. Service pipes with joint types other than bell end may be used. Details other than those shown may be used at joints while the different means of fastening the pipe to the steel plate may be used.

While the present invention has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An apparatus for accommodating pipes and conduits within road pavements, the apparatus comprising:
a steel plate of specific dimensions and structural properties;
at least one service pipe segment longitudinally fastened to the underside of said steel plate disposed to join with similarly arranged service pipes end to end to result in at least one continuous pipeline with said steel plates touching such that there is substantially no gap between consecutive steel plates.

2. The apparatus of claim 1 wherein a plate made from materials other than steel is used.

3. A method for installing said apparatus of claim 1 within road pavements, the method comprising;
a “T” section trench within a road pavement that fits a plurality of said steel plates and service pipes such that the underside of said steel plate is supported by the upper wide section of said trench and the top surface of said steel plate is a certain vertical distance below the surface of said road pavement to enable adequate thickness of surface course for permanent restoration of said road surface on top of said steel plate, with said service pipe suspended in lower narrow section of said trench without contact with said trench perimeter;
means of jointing said plurality of service pipes once inside said trench as per required technical specifications to form a continuous pipeline;

3. The method of claim 3 wherein said steel plate of claim 1 is secured inside said trench using a binder coat.

4. The method of claim 3 wherein said steel plate of claim 1 is secured inside said trench using nails.

5. The method of claim 3 wherein said service pipeline in said trench is encased in grout.
